(19) United States
(12) Patent Application Publication
(10) Pub. No.: US 2025/0119771 A1
(43) Pub. Date: Apr. 10, 2025

(54) NON-CELL-DEFINING SYNCHRONIZATION SIGNAL RELATED METHODS AND APPARATUS

(71) Applicant: ZTE Corporation, Shenzhen (CN)

(72) Inventor: Li ZHANG, Shenzhen (CN)

(21) Appl. No.: 18/988,212

(22) Filed: Dec. 19, 2024

Related U.S. Application Data
(63) Continuation of application No. PCT/CN2022/125986, filed on Oct. 18, 2022.

(51) Int. Cl. H04W 24/02

(52) U.S. Cl. CPC H04W 24/02

(57) ABSTRACT

Techniques and methods are described for non-cell-defining synchronization signal related methods and apparatus. An example communication method includes receiving, by a network device, a configuration information from a network node; and operating, by the network device, a network by selectively activating a transmission operation according to the configuration information or a status of the network device.

### CROSS-REFERENCE TO RELATED APPLICATION

This application is a continuation and claims priority to International Application No. PCT/CN2022/125986, filed on Oct. 18, 2022, the disclosure of which is hereby incorporated by reference herein in its entirety.

### TECHNICAL FIELD

This patent document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This patent document discloses techniques, among other things, for non-cell-defining synchronization signal related methods and apparatus.

In one example aspect, a first wireless communication method is disclosed. The method includes receiving, by a network device, a configuration information from a network node; and operating, by the network device, a network by selectively activating a transmission operation according to the configuration information or a status of the network device.

In another example aspect, another method of wireless communication is disclosed. The method includes transmitting, by a first network node, a message, to a second network node, wherein the message comprises information indicating a capacity status of a workload of the first network node.

In another example aspect, another method of wireless communication is disclosed. The method includes receiving, by a first network node, a message that includes information related a capacity status of a second network node; performing an operation by the first network node based on the capacity status.

In another example aspect, another method of wireless communication is disclosed. The method includes transmitting, by a network node, a configuration information about an extended Discontinuous Reception (eDRX) cycle for a RAN paging to a terminal node, wherein the configuration information indicates applicability of a cycle length that is greater than a threshold.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

The above and other aspects and their implementations are described in greater detail in the drawings, the descriptions, and the claims.

### BRIEF DESCRIPTION OF THE DRAWING

FIG. 1 shows an example flowchart for facilitating communication between a network device and a network.

FIG. 2 shows an example flowchart for another communication scenario between a terminal device and a network node.

FIG. 3 shows an example flowchart for transmitting a message from a first network node to a second network node.

FIG. 4 shows an example flowchart for receiving by a network node a message and reacting based on the indication of the message.

FIG. 5 shows an example flowchart for transmitting a configuration between a first network node and a second network node.

FIG. 6 shows an example flowchart for receiving by a network node a message and reacting based on the indication of the message.

FIG. 7 shows an exemplary block diagram of a hardware platform that may be a part of a network device or a communication device.

FIG. 8 shows an example of wireless communication system including a base station (BS) and user equipment (UE) based on some implementations of the disclosed technology.

### DETAILED DESCRIPTION

Headings for the various sections below are used to facilitate the understanding of the disclosed subject matter and do not limit the scope of the claimed subject matter in any way. Accordingly, one or more features of one section can be combined with one or more features of another section. Furthermore, 5G terminology is used for the sake of clarity of explanation, but the techniques disclosed in the present document are not limited to 5G technology only and may be used in wireless systems that implemented other protocols.

### INTRODUCTION

In 5G NR release 17 (Rel-17), the Third Generation Partnership Project (3GPP) introduced a new tier of reduced capability (RedCap) devices. To help with deployment of RedCap devices, certain barring framework is introduced in Rel-17 for RedCap devices. The barring framework provides protocol support to allow RedCap devices to find out whether they are allowed to join certain wireless networks.

The concept of RedCap devices is also being carried forward in the next release of 5G NR, called release 18 (Rel-18). For Rel-18 RedCap user equipment UEs, 5 MHz baseband BB bandwidth is restricted for physical downlink shared channel or physical uplink shared channel PDSCH/PUSCH. In addition, peak rate should also be restricted by relaxation of the constraint (vLayers·Qm·f≥4). However, currently no solutions are available for access control for Rel-18 RedCap UE. Accordingly, a barring framework for Rel-18 RedCap UEs may be useful in controlling access of such UEs will benefit wireless system deployments. However, no such barring frameworks exist.

To resolve the above problem, part of barring framework introduced in Rel-17 RedCap can be used for Rel-18 RedCap UE.

Besides, a new barring parameter can be introduced as a condition to control Rel-18 RedCap UE access, such as eRedCapAccessAllowed-r18.

If this parameter is set to bar, this cell is considered as barred.

In addition, this parameter is ignored for Rel-17 RedCap UE and non-RedCap UE.

For Rel-17 RedCap UEs, intraFreqReselectionRedCap and redCapAccessAllowed are introduced to control cell selection/reselection to intra-frequency/inter-frequency cells when this cell is barred or treated as barred by RedCap UE.

Similarly, for Rel-18 RedCap UE, separate parameters are used to control cell selection/reselection to intra/inter frequency cells may be introduced.

For eDRX cycle beyond 10.24s in RRC_INACTIVE, if some data are buffered in RAN, some flow controlling mechanisms need to be considered.

When RAN buffer is full or data volume in RAN buffer reaches a threshold, an indication of stopping sending MT data or sending a little data may be sent to UPF by RAN.

Besides, when data volume in RAN buffer do not reach a threshold or RAN buffer is not full, an indication of canceling flow control may be sent to UPF if flow control is used.

The present document provides solutions that may be implemented by various embodiments to solve the above-discussed problems, among others. The solutions are described as example embodiments, each providing a set of technical solutions that may be mixed and matched by practical implementation.

### Embodiment 1

In this embodiment, barring framework for Rel-17 RedCap UE is introduced. First, cellBarred in MIB can be used for RedCap UE.

If cellBarred is set to barred, this cell will be considered as barred, otherwise, if ssb-SubcarrierOffset indicates SIB1 is transmitted in the cell, the UE acquires SIB1.

Second, if intraFreqReselectionRedCap is not present in SIB1, this cell is considered as barred.

If intraFreqReselectionRedCap is present and if the cellBarredRedCap1Rx is present in the acquired SIB1 and is set to barred and the UE is equipped with 1 Rx branch; or if the cellBarredRedCap2Rx is present in the acquired SIB1 and is set to barred and the UE is equipped with 2 Rx branches; or if the halfDuplexRedCapAllowed is not present in the acquired SIB1 and the UE supports only half-duplex frequency division duplexing FDD operation, this cell is considered as barred.

The related parameters that can be used for controlling the cell access are defined as below in Table 1:

TABLE 1

| | | |
|---|---|---|
| halfDuplexRedCapAllowed-r17 | ENUMERATED {true} | OPTIONAL, -- Need R |
| cellBarredRedCap-r17 | SEQUENCE { | |
| cellBarredRedCap1Rx-r17 | ENUMERATED {barred, notBarred}, | |
| cellBarredRedCap2Rx-r17 | ENUMERATED {barred, notBarred} | |
| } | OPTIONAL, -- Need R | |
| intraFreqReselectionRedCap-r17 | ENUMERATED {allowed, notAllowed} | OPTIONAL, -- |
| Need S | | |
| redCapAccessAllowed-r17 | ENUMERATED {true} | OPTIONAL, -- Need R |

Barring framework for Rel-17 RedCap UE can also be used for Rel-18 RedCap UE.

Besides, since Rel-18 RedCap UE bandwidth is restricted within 5 MHz, a new barring parameter used for Rel-18 RedCap UE may be introduced to control these UEs access, such as eRedCapAccessAllowed-r18.

If it is set to barred, the cell is considered as barred, otherwise, if it is configured as notBarred, this cell is allowed to access.

A possible example is as below in Table 2:

TABLE 2

| | |
|---|---|
| eRedCapAccessAllowed-r18 | ENUMERATED {barred, notBarred} OPTIONAL, -- |

Need R

In addition, if this parameter is introduced, the corresponding spec description is as below:

Upon receiving the SIB1 the UE shall:

```
1>store the acquired SIB1;
1>if the UE is a RedCap UE or an eRedCap UE and it is in RRC_IDLE or in
  RRC_INACTIVE, or if the RedCap UE or eRedCap UE is in RRC_CONNECTED while
  T311 is running:
  2>if intraFreqReselectionRedCap is not present in SIB1:
    3>consider the cell as barred in accordance with TS 38.304 [20];
    3>perform barring as if intraFreqReselectionRedCap is set to allowed;
  2> else:
    3>if the cellBarredRedCap1Rx is present in the acquired SIB1 and is set to barred and
      the UE is equipped with 1 Rx branch; or
    3>if the cellBarredRedCap2Rx is present in the acquired SIB1 and is set to barred and
      the UE is equipped with 2 Rx branches; or
    3>if the halfDuplexRedCapAllowed is not present in the acquired SIB1 and the UE
      supports only half-duplex FDD operation; or
    3>if the eRedCapAccessAllowed is present in the acquired SIB1 and is set to barred:
      4>consider the cell as barred in accordance with TS 38.304 [20];
      4>perform barring based on intraFreqReselectionRedCap as specified in TS 38.304
        [20];
```

### Embodiment 2

In this embodiment, we first introduce the barring framework for Rel-17 RedCap UE.

First, cellBarred in MIB can be used for RedCap UE. If cellBarred is set to barred, this cell will be considered as barred, otherwise, if ssb-SubcarrierOffset indicates SIB1 is transmitted in the cell, the UE acquires SIB1.

Second, if intraFreqReselectionRedCap is not present in SIB1, this cell is considered as barred. If intraFreqReselectionRedCap is present and if the cellBarredRedCap1Rx is present in the acquired SIB1 and is set to barred and the UE is equipped with 1 Rx branch; or if the cellBarredRedCap2Rx is present in the acquired SIB1 and is set to barred and the UE is equipped with 2 Rx branches; or if the halfDuplexRedCapAllowed is not present in the acquired SIB1 and the UE supports only half-duplex FDD operation, this cell is considered as barred. In other words, the parameters below can be used for controlling the cell access.

TABLE 3

| | | |
|---|---|---|
| halfDuplexRedCapAllowed-r17 | ENUMERATED {true} | OPTIONAL, -- Need R |
| cellBarredRedCap-r17 | SEQUENCE { | |
| cellBarredRedCap1Rx-r17 | ENUMERATED {barred, notBarred}, | |
| cellBarredRedCap2Rx-r17 | ENUMERATED {barred, notBarred} | |
| } | OPTIONAL, -- Need R | |
| intraFreqReselectionRedCap-r17 | ENUMERATED {allowed, notAllowed} | OPTIONAL, -- |
| Need S | | |
| redCapAccessAllowed-r17 | ENUMERATED {true} | OPTIONAL, -- Need R |

Barring framework for Rel-17 RedCap UE can also be used for Rel-18 RedCap UE. Besides, since Rel-18 RedCap UE bandwidth is restricted within 5 MHz, a new barring parameter used for Rel-18 RedCap UE may be introduced to control these UEs access, such as eRedCapAccessAllowed-r18. If it is set to barred, the cell is considered as barred, otherwise, if it is configured as notBarred, this cell is allowed to access.

A possible example is as below:

TABLE 4

| | |
|---|---|
| eRedCapAccessAllowed-r18 | ENUMERATED {barred, notBarred} OPTIONAL, |

-- Need S

TABLE 5
SIB1 field descriptions

eRedCapAccessAllowed
Value barred means that the cell is barred for Rel-18 eRedCap UE, as
defined in TS 38.304
[20]. If not present, the UE considers the cell is not allowed for Rel-18
RedCap UE accessing,
as defined in TS 38.304 [20]. This field is ignored by non-RedCap UEs
and Rel-17 RedCap
UEs.

When eRedCapAccessAllowed is not broadcast in this cell, for Rel-18 RedCap access, the UE shall treat this cell as if cell status is “barred”.

In addition, if this parameter is introduced, the corresponding spec description is as below:

Upon receiving the SIB1 the UE shall:

```
1>store the acquired SIB1;
1>if the UE is a RedCap UE or an eRedCap UE and it is in RRC_IDLE or in
  RRC_INACTIVE, or if the RedCap UE or eRedCap UE is in RRC_CONNECTED while
  T311 is running:
  2>if intraFreqReselectionRedCap is not present in SIB1:
    3>consider the cell as barred in accordance with TS 38.304 [20];
    3>perform barring as if intraFreqReselectionRedCap is set to allowed;
  2> else:
    3>if the cellBarredRedCap1Rx is present in the acquired SIB1 and is set to barred and
      the UE is equipped with 1 Rx branch; or
    3>if the cellBarredRedCap2Rx is present in the acquired SIB1 and is set to barred and
      the UE is equipped with 2 Rx branches; or
    3>if the halfDuplexRedCapAllowed is not present in the acquired SIB1 and the UE
      supports only half-duplex FDD operation; or
    3>if the eRedCapAccessAllowed is present in the acquired SIB1 and is set to barred:
      4>consider the cell as barred in accordance with TS 38.304 [20];
      4>perform barring based on intraFreqReselectionRedCap as specified in TS 38.304
        [20];
```

### Embodiment 3

This embodiment discloses a signaling design in Rel-18 allowing RedCap UEs to conduct intra/inter frequency reselection operations.

In Rel-17 RedCap, intraFreqReselectionRedCap and redCapAccessAllowed are introduced to control cell selection/reselection to intra-frequency/inter-frequency cells for RedCap UEs when this cell is barred or treated as barred by RedCap UE.

The parameters are disclosed in the following table.

TABLE 6

| | | |
|---|---|---|
| intraFreqReselectionRedCap-r17 | ENUMERATED {allowed, notAllowed} | OPTIONAL, |

-- Need S

| | | |
|---|---|---|
| redCapAccessAllowed-r17 | ENUMERATED {true} | OPTIONAL, -- Need R |

For Rel-18 RedCap UE, considering the flexibility and special treatment, the separate parameters for intra/inter frequency cell reselection are defined, such as intraFreqReselectioneRedCap-r18 and eRedCapAccessAllowed-r18.

### Embodiment 4

This embodiment discloses a barring scheme design in Rel-18 for RedCap UEs.

We first introduce barring framework for Rel-17 RedCap UEs.

Firstly, cellBarred in MIB can be used for RedCap UE. If cellBarred is set to barred, this cell will be considered as barred, otherwise, if ssb-SubcarrierOffset indicates SIB1 is transmitted in the cell, the UE acquires SIB1.

Secondly, if intraFreqReselectionRedCap is not present in SIB1, this cell is considered as barred. If intraFreqReselectionRedCap is present and if the cellBarredRedCap1Rx is present in the acquired SIB1 and is set to barred and the UE is equipped with 1 Rx branch; or if the cellBarredRedCap2Rx is present in the acquired SIB1 and is set to barred and the UE is equipped with 2 Rx branches; or if the halfDuplexRedCapAllowed is not present in the acquired SIB1 and the UE supports only half-duplex FDD operation, this cell is considered as barred. In other words, the parameters below can be used for controlling the cell access.

The parameters are disclosed in the following table.

TABLE 7

| | | |
|---|---|---|
| halfDuplexRedCapAllowed-r17 | ENUMERATED {true} | OPTIONAL, -- Need |
| R | | |
| cellBarredRedCap-r17 | SEQUENCE { | |
| cellBarredRedCap1Rx-r17 | ENUMERATED {barred, notBarred}, | |
| cellBarredRedCap2Rx-r17 | ENUMERATED {barred, notBarred} | |
| } | OPTIONAL, -- Need R | |

For Rel-18 RedCap UEs, cellBarred in MIB can be used similar to Rel-17 RedCap/non-RedCap UE.

Besides, separate barring parameters can be used for Rel-18 RedCap UE considering access control flexibility, such as halfDuplexeRedCapAllowed-r18, cellBarredeRedCap1Rx-r18 and cellBarredeRedCap2Rx-r18. Considering Rel-18 RedCap UE bandwidth can be restricted within 5 MHz, another parameter can also be introduced, such as eRedCapAccess-r18.

These new introduced parameters for Rel-18 RedCap UEs may be configured in SIB1 or other messages.

### Embodiment 5

This embodiment discloses a communication scheme between a base station and the core-network to effectively control the flow transmission in the based station side.

In some cases, RAN may buffer MT data from CN. If RAN buffering capability is restricted, flow control between RAN and UPF needs to be considered.

When RAN buffer is full or data volume in RAN buffer reaches a threshold, an indication of stopping sending MT data or sending a little data may be sent to UPF by RAN. When receiving an indication from RAN, the UPF in core network may send confirm information to RAN. And in the following, a UPF may stop sending MT data or sending a little data to RAN. Alternatively, upon receiving this indication, a UPF may stop sending MT data or sending a little data to RAN, i.e. there is no confirmation indication to RAN.

Besides, when data volume in RAN buffer do not reach a threshold or RAN buffer is not full, an indication of canceling flow control may be sent to UPF if data may be buffered in RAN. Then in the following, once there is MT data, UPF may send MT data to RAN.

The threshold above may be configured by OAM.

### Embodiment 6

This embodiment discloses a communication scheme between a base station and a user device to notify the user device certain support scheme in Rel-18 for RedCap UEs.

In Rel-17 RedCap, eDRX is introduced for RRC_IDLE UEs and RRC_INACTIVE UEs. For RRC_IDLE UEs, eDRX cycle up to 10487.56s may be configured, while for RRC_INACTIVE UEs, eDRX cycle up to 10.24s may be configured.

In Rel-18 RedCap, eDRX cycle beyond 10.24s for RRC_INACTIVE UEs can be introduced.

For Rel-18 RedCap UEs, firstly, the UE capability should be introduced, such as Rel-18 extended DRX in RRC_INACTIVE. This capability is optional for UE to support Rel-18 extended DRX cycle up to 10485.76s and paging in extend DRX in RRC_INACTIVE. Secondly, a RRC parameter can also be introduced, which is used to control whether extend DRX beyond 10.24s is allowed for RRC_INACTIVE UEs, such as eDRXWithLongCycle-AllowedInactive. The UE shall stop using extended long DRX in RRC_INACTIVE if eDRXWithLongCycle-AllowedInactive is not present.

A possible example for UE capability and RRC parameter definition is as below:

TABLE 8
Rel-18 extended DRX in RRC_INACTIVE
It is optional for UE to support Rel-18 extended long DRX cycle up to
10485.76
seconds and paging in extended DRX in RRC_INACTIVE

TABLE 9
eDRXWithLongCycle-AllowedInactive
The presence of this field indicates that extended long DRX is allowed in
the cell for
UEs in RRC_INACTIVE. The UE shall stop using extended DRX in
RRC_INACTIVE if
eDRXWithLongCycle-AllowedInactive is not present.

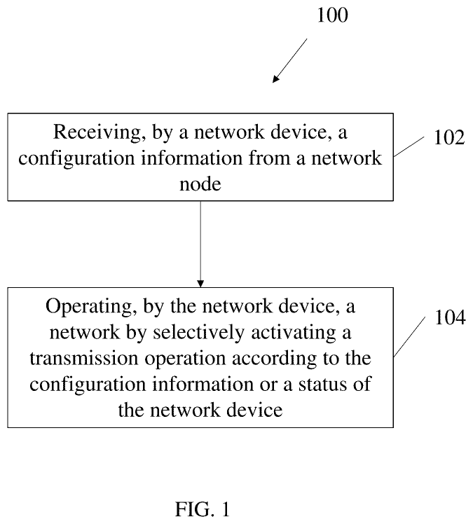

FIG. 1 shows an example flowchart for facilitating communication between a network device and a network. Operation 102 includes receiving, by a network device, a configuration information from a network node. Operation 104 operating, by the network device, a network by selectively activating a transmission operation according to the configuration information or a status of the network device.

In some embodiments, the transmission operation is refrained in the network when the network device is of reduced capacity; and 1) the configuration information fails to include a first parameter or 2) the configuration information includes a second parameter set to barred. In some embodiments, the first parameter indicates whether an intra frequency reselection operation is supported in the network. In some embodiments, the method described in FIG. 1 further comprising determining to support only half-duplex FDD operation the configuration information comprises the first parameter and fails to include a third parameter. In some embodiments, the method described in FIG. 1 further comprising determining to equip one antenna when the configuration information comprises the first parameter and fails to include a third parameter. In some embodiments, the method described in FIG. 1 further comprising determining to equip two antennas when the configuration information comprises the first parameter and fails to include a third parameter. In some embodiments, the method described in FIG. 1 further comprising determining to conduct intra-frequency reselection operation when the configuration information fails to include the first parameter or according to a pre-configured standard and the first parameter.

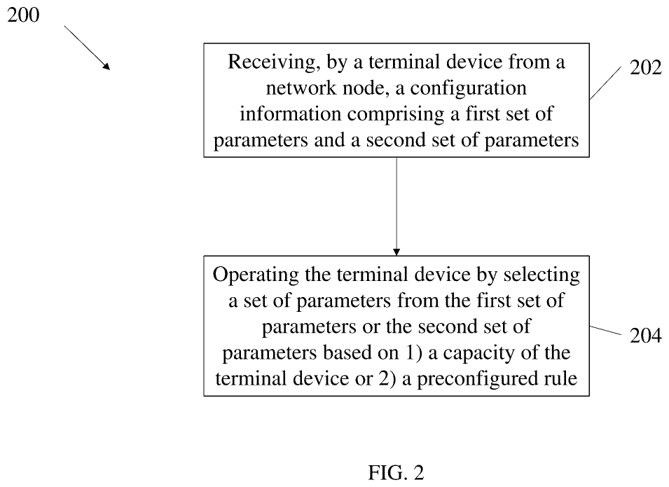

FIG. 2 shows an example flowchart for another communication scenario between a terminal device and a network node. Operation 602 includes receiving, by a terminal device from a network node, a configuration information comprising a first set of parameters and a second set of parameters. Operation 604 includes operating the terminal device by selecting a set of parameters from the first set of parameters or the second set of parameters based on 1) a capacity of the terminal device or 2) a preconfigured rule.

In some embodiments, the first parameter set comprises a plurality of parameters, wherein each of the plurality of parameters has a correspondent parameter in the second parameter set. In some embodiments, first set of parameters is adopted when the terminal device is a reduced capacity (RedCap) UE; wherein the second set of parameters is adopted when the terminal device is an enhanced reduced capacity (eRedCap) UE. In some embodiments, the selected parameter set comprises a parameter indicating to conduct reselection in inter or intra frequencies. In some embodiments, the selected parameter set comprises a parameter indicating whether the network is barred for the communication device for reselection operations. In some embodiments, the selected parameter set comprises a parameter indicating whether a certain frame structure is allowed in a current network.

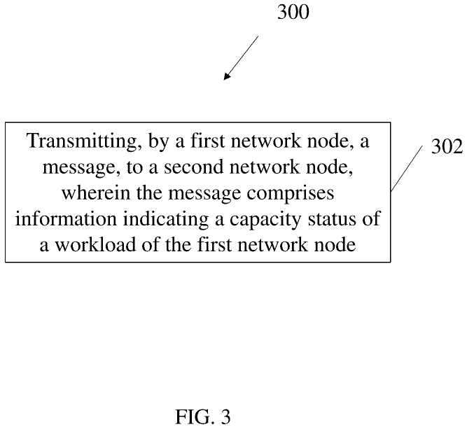

FIG. 3 shows an example flowchart for transmitting a message from a first network node to a second network node. Operation 502 includes transmitting, by a first network node, a message, to a second network node, wherein the message comprises information indicating a capacity status of a workload of the first network node.

In some embodiments, the operation comprising stop sending a type of data when the capacity status indicating the first network node's capacity drops below a threshold. In some embodiments, the operation comprising sending a type of data when the capacity status indicating the first network node's capacity is above a threshold. In some embodiments, the example in FIG. 3 further comprising transmitting, by the first network node, upon receiving the message, a confirmation message to the second network node.

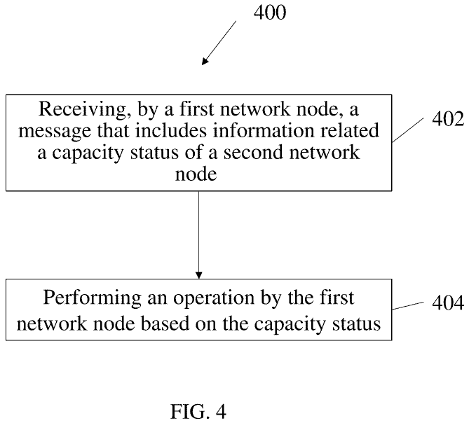

FIG. 4 shows an example flowchart for receiving by a network node a message and reacting based on the indication of the message. Operation 602 includes receiving, by a first network node, a message that includes information related a capacity status of a second network node. Operation 604 includes performing an operation by the first network node based on the capacity status.

In some embodiments, the operation comprising stop sending a type of data when the capacity status indicating the first network node's capacity drops below a threshold. In some embodiments, the operation comprising sending a type of data when the capacity status indicating the first network node's capacity is above a threshold. In some embodiments, the example in FIG. 4 further comprising transmitting, by the first network node, upon receiving the message, a confirmation message to the second network node.

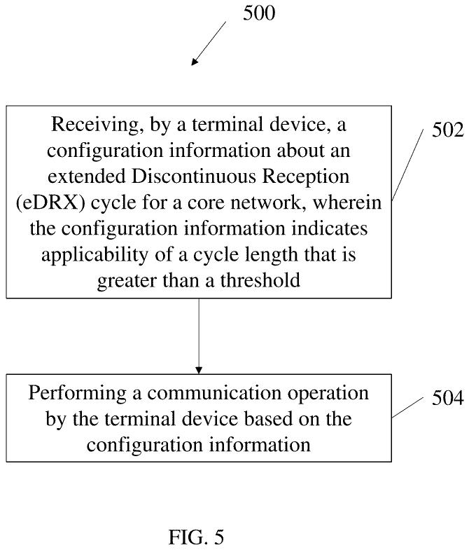

FIG. 5 shows an example flowchart for transmitting a configuration between a first network node and a second network node. Operation 502 includes transmitting, by a network node, a configuration information about an extended Discontinuous Reception (eDRX) cycle for a RAN paging to a terminal node, wherein the configuration information indicates applicability of a cycle length that is greater than a threshold.

In some embodiments, the threshold is 10.24 seconds. In some embodiments, the configuration information is a RRC parameter. In some embodiments, the performing a communication operation comprising determining stop using a long eDRX mode when a parameter is not included in the configuration information. In some embodiments, the performing a communication operation comprising determining a long eDRX mode is allowed in a network when a parameter is included in the configuration information.

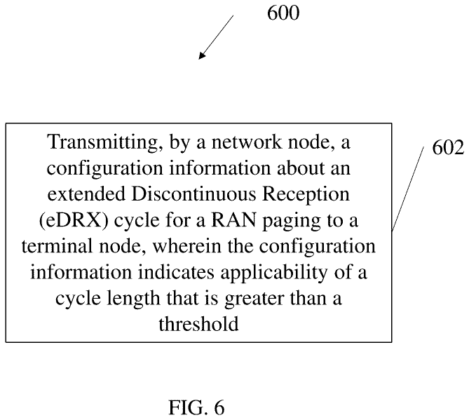

FIG. 6 shows an example flowchart for receiving by a network node a message and reacting based on the indication of the message. Operation 602 includes receiving, by a first network node, a first request message that includes a key identifier and a user identifier, wherein the user identifier is associated with a communication device. Operation 604 includes determining, by the first network node in response to the receiving, to selectively send one of: (a) a response message to a second network node, or (b) a second request message to a third network node, based on a decision rule.

In some embodiments, the threshold is 10.24 seconds. In some embodiments, the configuration information is a RRC parameter. In some embodiments, the performing a communication operation comprising determining stop using a long eDRX mode when a parameter is not included in the configuration information. In some embodiments, the performing a communication operation comprising determining a long eDRX mode is allowed in a network when a parameter is included in the configuration information.

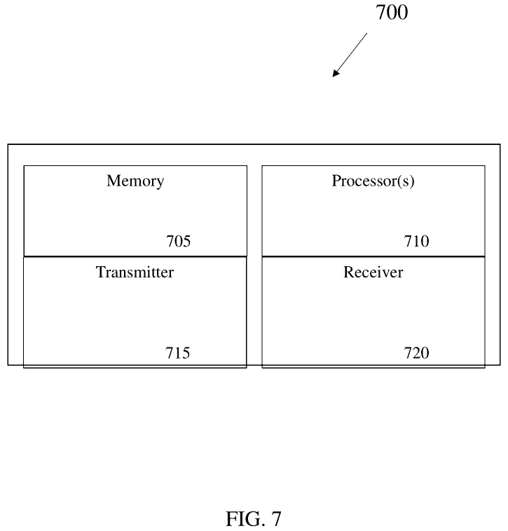

FIG. 7 shows an exemplary block diagram of a hardware platform 700 that may be a part of a network device (e.g., base station) or a communication device (e.g., a user equipment (UE)). The hardware platform 700 includes at least one processor 710 and a memory 705 having instructions stored thereupon. The instructions upon execution by the processor 710 configure the hardware platform 700 to perform the operations described in FIGS. 1 to 6 and in the various embodiments described in this patent document. The transmitter 715 transmits or sends information or data to another device. For example, a network device transmitter can send a message to user equipment. The receiver 720 receives information or data transmitted or sent by another device. For example, user equipment can receive a message from a network device.

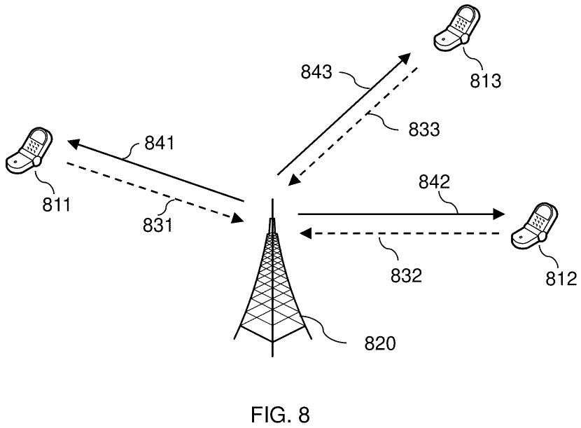

The implementations as discussed above will apply to a wireless communication. FIG. 8 shows an example of a wireless communication system (e.g., a 5G or NR cellular network) that includes a base station 820 and one or more user equipment (UE) 811, 812 and 813. In some embodiments, the UEs access the BS (e.g., the network) using a communication link to the network (sometimes called uplink direction, as depicted by dashed arrows 831, 832, 833), which then enables subsequent communication (e.g., shown in the direction from the network to the UEs, sometimes called downlink direction, shown by arrows 841, 842, 843) from the BS to the UEs. In some embodiments, the BS send information to the UEs (sometimes called downlink direction, as depicted by arrows 841, 842, 843), which then enables subsequent communication (e.g., shown in the direction from the UEs to the BS, sometimes called uplink direction, shown by dashed arrows 831, 832, 833) from the UEs to the BS. The UE may be, for example, a smartphone, a tablet, a mobile computer, a machine to machine (M2M) device, an Internet of Things (IoT) device, and so on.

It will be appreciated that the present document discloses multiple communication scheme designs in Rel-18 for RedCap UEs. A RedCap device, also known as NF-Light is a new device platform that bridges the capability and complexity gap between the extreme in 5G with an optimized design for mid-tier use cases. When compared with other devices, RedCap devices can efficiently support transmission in both downlink and uplink, respectively, due to the designed optimizations. Due to the benefits of RedCap devices and certain limitations of such devices, how RedCap fits into 5G system becomes an issue. Rel-17 has certain designs to restrict the RedCap UE activities in certain networks. No such design exists in Rel-18. It will be appreciated that the present document provides multiple schemes related to Rel-18 RedCap UEs to 1) incorporate the Rel-17 barring cell design into Rel-18, and 2) effectively control flow between the base states and the core-networks and 3) allow RedCap UEs to conduct activities based on received configuration information.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A wireless communication method, comprising:
receiving, by a network device, a configuration information from a network node; and
operating, by the network device, a network by selectively activating a transmission operation according to the configuration information or a status of the network device, wherein the transmission operation is refrained in the network when the network device is of reduced capacity.

2. The method of claim 1, wherein the configuration information fails to include a first parameter indicating whether an intra frequency reselection operation is supported in the network.

3. The method of claim 1, wherein the configuration information includes a second parameter that is set to barred.

4. The method of claim 2, further comprising at least one of:
determining to support only half-duplex FDD operation when the configuration information comprises the first parameter and fails to include a third parameter,
determining to equip one antenna when the configuration information comprises the first parameter and fails to include a third parameter,
determining to equip two antennas when the configuration information comprises the first parameter and fails to include a third parameter, or
determining to conduct intra-frequency reselection operation when the configuration information fails to include the first parameter or according to a pre-configured standard and the first parameter.

5. A communication method, comprising:
receiving, by a terminal device from a network node, a configuration information comprising a first set of parameters and a second set of parameters, wherein the first set of parameters comprises a plurality of parameters, wherein each of the plurality of parameters has a corresponding parameter in the second set of parameters; and
operating the terminal device by selecting a set of parameters from the first set of parameters or the second set of parameters based on 1) a capacity of the terminal device or 2) a preconfigured rule.

6. The method of claim 5, wherein the first set of parameters is adopted when the terminal device is a reduced capacity (RedCap) UE.

7. The method of claim 5, wherein the second set of parameters is adopted when the terminal device is an enhanced reduced capacity (eRedCap) UE.

8. The method of claim 5, wherein the selected set of parameters comprises at least one of a parameter indicating to conduct reselection in inter or intra frequencies, a parameter indicating whether the network is barred for the terminal device for reselection operations, or a parameter indicating whether a certain frame structure is allowed in a current network.

9. A terminal device, comprising at least one processor, wherein the at least one processor is configured to cause the terminal device to implement a method, the method comprising:
receiving from a network node, a configuration information comprising a first set of parameters and a second set of parameters, wherein the first set of parameters comprises a plurality of parameters, wherein each of the plurality of parameters has a corresponding parameter in the second set of parameters; and
selecting a set of parameters from the first set of parameters or the second set of parameters based on 1) a capacity of the terminal device or 2) a preconfigured rule.

10. The terminal device of claim 9, wherein the first set of parameters is adopted when the terminal device is a reduced capacity (RedCap) UE.

11. The terminal device of claim 9, wherein the second set of parameters is adopted when the terminal device is an enhanced reduced capacity (eRedCap) UE.

12. The terminal device of claim 9, wherein the selected set of parameters comprises a parameter indicating to conduct reselection in inter or intra frequencies.

13. The terminal device of claim 9, wherein the selected set of parameters comprises a parameter indicating whether the network is barred for the terminal device for reselection operations.

14. The terminal device of claim 9, wherein the selected set of parameters comprises a parameter indicating whether a certain frame structure is allowed in a current network.

15. A network device, comprising at least one processor, wherein the at least one processor is configured to cause the network device to implement the method recited in claim 1.

16. The network device of claim 15, wherein the configuration information fails to include a first parameter indicating whether an intra frequency reselection operation is supported in the network.

17. The network device of claim 15, wherein the configuration information includes a second parameter that is set to barred.

18. The network device of claim 16, the method further comprising at least one of:
determining to support only half-duplex FDD operation when the configuration information comprises the first parameter and fails to include a third parameter; or
determining to equip one antenna when the configuration information comprises the first parameter and fails to include a third parameter.

19. The network device of claim 16, the method further comprising determining to equip two antennas when the configuration information comprises the first parameter and fails to include a third parameter.

20. The network device of claim 16, the method further comprising determining to conduct intra-frequency reselection operation when the configuration information fails to include the first parameter or according to a pre-configured standard and the first parameter.
